(19) United States
(12) Patent Application Publication
(10) Pub. No.: US 2005/0001194 A1
(43) Pub. Date: Jan. 6, 2005

(54) Pressurized gas coupling

(76) Inventor: Patrick E. Bachelder, Battle Creek, MI (US)

Correspondence Address: Waters & Morse, P.C., 400 Ledyard Building, 125 Ottawa, Avenue, NW, Grand Rapids, MI, 49503, US

(21) Appl. No.: 10/613,178

(22) Filed: Jul. 3, 2003

(51) Int. Cl. F16L 37/28

(52) U.S. Cl. 251/149.6

(57) ABSTRACT

A method for producing a valve holder assembly for an automatic gas shutoff valve in a pressurized gas coupling comprises mounting a compressible annular gasket on a cylindrical portion of the valve holder adjacent an enlarged flange that abuts an outer side of the gasket; mounting a retaining washer on the cylindrical portion adjacent an outer side of the gasket, the cylindrical portion extending outwardly past the retaining washer and terminating at a shoulder; and flaring the shoulder radially outwardly so as to form a retaining cap on an outer side of the retaining washer, thereby locking the gasket on the valve holder, by applying a rotary forming tool against the shoulder on the cylindrical portion. The coupling desirably includes shutoff valves in male and female components, with identical valve holder assemblies being used in both coupling components. A powdered metal guide can be used for a stem on the valve holder.

### BACKGROUND OF THE INVENTION

The present invention relates to a releasable coupling for connecting a gas burning or gas driven device to a source of pressurized gas.

Many devices are powered by pressurized gas. One type of device is a forklift truck, wherein liquid pressurized gas, such as propane, provides fuel for the vehicle drive system.

In a system powered by pressurized gas, it is necessary to provide a releasable coupling to connect the gas source to the gas driven device. Such couplings can be connected together in a number of ways, including a conventional threaded coupling wherein a male coupling component is threaded into a female coupling component.

Couplings usually incorporate automatic shutoff valves that are closed automatically when the couplings are separated and opened automatically when the couplings are connected. Automatic shutoff valves are often incorporated in both the male and female portions of the coupling, so that gas is cut off from the source as well as from the driven device when the couplings are separated.

Shutoff valves used in couplings of the type disclosed in the present invention generally include an elongated metal body or valve holder that reciprocates in a valve chamber, with a gasket formed of a molded rubber type of material fitting on the valve holder and engaging a valve seat in the valve chamber. The gasket is generally held in place by a retaining washer that clamps the gasket in place. These valve holder assemblies heretofore have been somewhat complex and have involved considerable expense in assembly.

An object of the present invention is to provide a coupling with a valve holder assembly and a method for assembling same that is effective and yet is cost effective. Another object of the present invention is to provide a coupling having male and female coupling valve holder assemblies that are interchangeable.

### SUMMARY OF THE INVENTION

In accordance with one aspect of the present invention, a method for producing a valve holder assembly for an automatic gas shutoff valve in a pressurized gas coupling comprises: providing a valve holder with an enlarged flange and a cylindrical portion extending inwardly therefrom; fitting a compressible annular gasket over the cylindrical portion into engagement with the flange; fitting a retaining washer over the cylindrical portion into a position adjacent to an outer side of the gasket, the cylindrical portion being formed so as to extend outwardly past the retaining washer and terminating at a shoulder; and applying a rotary forming tool (preferably an orbital riveter) against the shoulder on the cylindrical portion, such that the portion of the cylindrical portion from the shoulder to the retaining washer is flared radially outwardly so as to form a retaining cap on an outer side of the retaining washer, thereby locking the gasket on the valve holder.

Desirably, the cylindrical portion has a first portion on which the gasket is mounted and an inwardly adjacent second portion of lesser diameter on which the retaining washer is mounted, forming a shoulder between the first and second portions against which the retaining washer fits. The forming tool deforms the cylindrical portion on the inner side of the retaining washer and produces a flared end that holds the retaining ring between the flared end and the shoulder between the first and second portions of the cylindrical portion. The valve holder in the preferred invention includes a narrower nipple on the inside of the second portion, forming a shoulder therebetween, which the forming tool bears against to form the flared end.

In common practice, a gas coupling is formed with automatic shutoff valves in each of a male and female coupling components, with each component including a valve holder assembly for opening and closing the valve. In another aspect of the present invention, the coupling is formed with identical valve holders for the male and female coupling components, such that the valve holders for the male and female couplings are interchangeable.

The valve holder of the present invention also includes a stem that is slidably mounted for linear motion in an opening in a guide mounted in the valve chamber. The guide comprises an annular collar having legs around the outer periphery thereof that extend outwardly from the collar to an interior surface of the valve chamber. Forming the guide out of powdered metal can provide cost savings for manufacturers.

A valve holder constructed in accordance with the foregoing method is effective in an automated shutoff valve, yet provides substantial savings in the manufacturing process.

### BRIEF DESCRIPTION OF THE DRAWINGS

FIG. 1 is a side elevational view of a coupling constructed in accordance with the present invention, showing the male and female coupling components separated.

FIG. 2 is an enlarged fragmentary side elevational view of the gasket mounting mechanism of the present invention.

FIG. 3 is a cross sectional view taken along line 3-3 of FIG. 1.

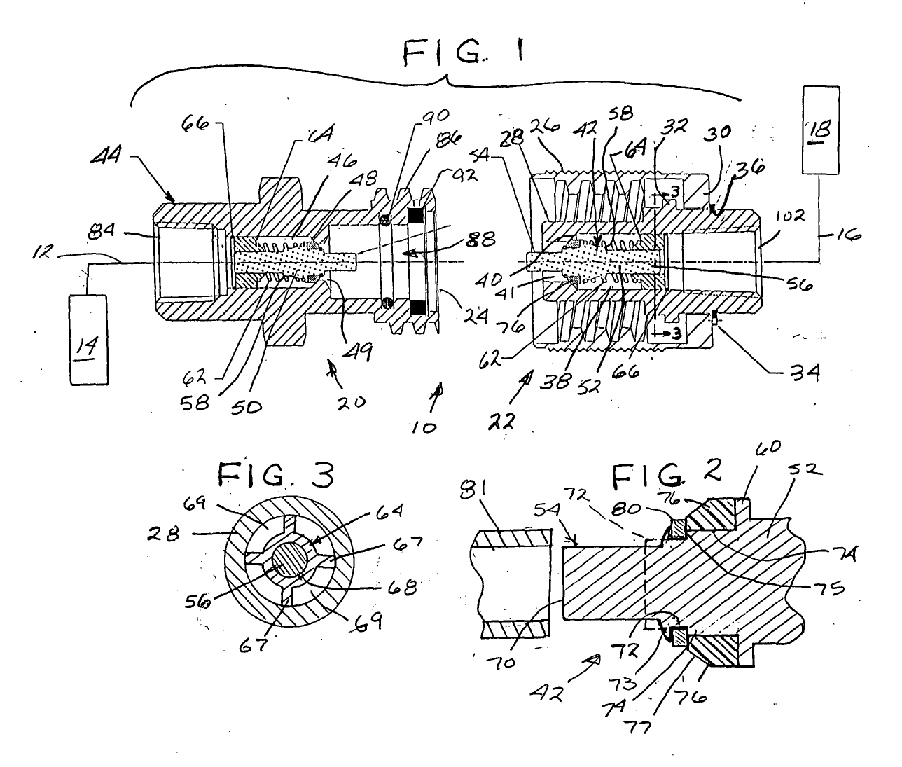

### DETAILED DESCRIPTION OF PREFERRED EMBODIMENT

In accordance with the present invention, the present invention comprises an improved coupling for releasably connecting a hose or outlet 12 from a pressurized gas container 14 (shown schematically) with a hose 16 leading to a gas powered device 18 (shown schematically). The present invention has particular application to a forklift truck operated by pressurized gas, such as propane. A person skilled in the art will recognize that the principles of the present invention are applicable to pressurized gas couplings in general.

Coupling 10 comprises a male component 20 and a female component 22, with the male component having an externally threaded inner end 24 that mates with an internally threaded nut 26, which is rotatably mounted on body 28 of female component 22. A flange 30 at the outer end of nut 26 fits over a cylindrical portion of body 28 between a radially extending flange 32 on the body and an external retaining ring 34 which fits in a groove 36. The nut is thus rotatably mounted on body 28.

Body 28 of the female component (also called female connector) has an internal valve opening or valve chamber 38 extending therethrough with a tapered annular valve seat 40 being positioned adjacent a valve port 41 at an inner end of the valve chamber. A reciprocating valve holder assembly 42 (also called valve member) is mounted in valve chamber 38 and is axially movable therein.

Similarly, male component 20 comprises a body 44 having a valve opening or valve chamber 46 therein, which has a valve seat 48 adjacent a valve port 49 at an inner end thereof. A valve holder assembly 50 (also called valve member) is axially movable in the valve chamber. A feature of the present invention is that the valve holder assemblies 50 and 42 for the male and female components of the coupling desirably are identical and are interchangeable. Thus, the present invention requires tooling only for a single valve holder assembly. Previously, separate valve holder assemblies of different configurations were required.

Referring again to the female connector, the valve holder assembly 42 comprises an elongated valve holder 52 typically formed of a formable metal such as brass, with the valve holder having a nipple 54 at an inner end and having a stem 56 at an outer end. The valve holder has a circular cross section and is typically formed by turning a brass blank on a lathe. Extending from the stem toward the nipple, the stem extends to an enlarged shoulder 58 and then the valve holder tapers radially outwardly to a flange 60. A spring 62 abuts against flange 60 and extends outwardly into contact with a guide 64 that is held in position in valve opening 38 by means of an internal retaining ring 66. Guide 64 has an opening 68 therethrough that receives stem 56 therein for reciprocal motion. Guide 64 has spaced radial legs 67 on an outer periphery that extend radially to the inner wall of the valve chamber, leaving channels 69 between the legs for gas to flow past the guide. Guide 64 can be extruded or can be formed out of powdered metal.

Nipple 54 at the other end of the valve holder also has a circular cross section and extends in an axial direction from end 70 to cylindrical portion 72, which has a somewhat larger diameter. Portion 72 extends outwardly into abutment with a cylindrical portion 74, which, in the illustrated embodiment, has a somewhat larger diameter, forming a shoulder 75 between portions 72 and 74. Portion 74 extends into contact with flange 60.

A gasket 76 having a generally annular shape fits closely on portion 74 of the valve holder and abuts flange 60. Gasket 76 has a beveled valve surface 77 thereon that mates with valve seat 40. Gasket 76 is conventional and is typically formed of a resilient molded rubber compound, such as nitrile/buna, or buna/N. A slightly compressible gasket material is necessary to provide a gas tight seal between the valve and the valve seat.

An important feature of the present invention is the manner in which the gasket is mounted on the valve holder. In the present invention, a retaining washer 80 fits closely over portion 72 into abutment with shoulder 75 and an end of gasket 76, with gasket 76 being substantially the same axial length as portion 74. With the retaining washer in place, a rotary forming tool such as an orbital riveter 81 (shown schematically) of conventional design is fitted over nipple 54 and actuated against an outer end of portion 72. The orbital riveter rotates around the nipple and presses against portion 72, flaring the outer end 73 of portion 72 outwardly in mushroom fashion, pinching the retaining washer between the flared outer end and the shoulder 75 on portion 74. Portion 74 terminates at substantially the same point as gasket 76, so the retaining ring is positioned to hold the gasket in position on the valve holder. This process eliminates a substantial amount of cost in the manufacturing and assembly of a valve holder assembly.

Another feature of the present invention is that the valve holder assembly 42 used in the female connector, as described above, is the same as the valve holder assembly 50 used for the male component of the connector. Thus, a single valve holder assembly, manufactured as described above, can be used for both components of the connector, eliminating the necessity of maintaining an inventory of two different parts and distinguishing between the parts for assembly of a connector.

In operation, the male component of the valve holder assembly is connected to a tank 14 of pressurized gas (shown schematically) by means of fitting 84 on an end of the body of the male component. Threads 86 at the opposite end 24 of the body 44 engage internally threaded nut 26 on the female component 22, drawing body 28 of the female component into opening 88 in the adjacent end of the male component. An O-ring 90 and seal gasket 92 extending in grooves around the inner periphery of the opening 88 provide a sealed connection between body 28 and opening 88. As the two components are drawn together by the rotation of nut 26, the nipples on the two valve holder assemblies engage and force each of the valve holder assemblies outwardly, away from sealing contact with their respective valve seats. Springs 62 urge the valve holder assemblies toward their closed positions, which are shown in the drawings. In order to insure that both valves open, the shoulder 58 at the rear portion of valve holder 52 is positioned so that it engages guide 64 after the valve has opened and the valve holder has moved a predetermined distance. This shoulder limits the amount that the valve holder can move to a distance that is sufficient to insure that both valve holders are fully opened when the connector is completely engaged. Desirably, the valve holders are set up so that the female valve holder starts to open first, before the male valve holder.

The female connector, in operation, is connected to the device being powered by the pressurized gas. In the exemplary embodiment, the device can be a forklift truck 18 (shown schematically) connected by hose 16 to the connector by means of a suitable fitting on the end of the hose. The hose fitting engages internally threaded connector opening 102 in the outer end of female connector body 28.

It should be understood that the foregoing is merely exemplary of the preferred practice of the present invention and that various changes and modifications in the arrangements and details of construction of the embodiments disclosed herein may be made without departing from the spirit and scope of the present invention.

1. A method for producing a valve holder assembly for an automatic gas shutoff valve in a pressurized gas coupling, wherein the valve holder assembly includes a compressible annular gasket mounted on an elongated formable metal valve holder, the method comprising:
providing a valve holder that includes an enlarged flange and a cylindrical portion extending inwardly therefrom;
providing a compressible gasket that fits closely over the cylindrical portion;
mounting the gasket on the cylindrical portion, with an outer side abutting the enlarged flange;
fitting a retaining washer over the cylindrical portion into a position adjacent to an outer side of the gasket, the cylindrical portion extending outwardly past the retaining washer and terminating at a shoulder; and
applying a rotary forming tool against the shoulder on the cylindrical portion, such that the portion of the cylindrical portion from the shoulder to the retaining washer is flared radially outwardly so as to form a retaining cap on an outer side of the retaining washer, thereby locking the gasket on the valve holder.

2. A method as in claim 1 wherein the cylindrical portion has a first portion on which the gasket is mounted and an inwardly adjacent portion of lesser diameter on which the retaining washer is mounted, forming a shoulder between the first and second portions against which the retaining washer fits, the forming tool deforming the cylindrical portion on the inner side of the retaining washer and producing a flared end that holds the retaining ring between the flared end and the shoulder between the first and second portions of the cylindrical portion.

3. A method as in claim 1 wherein the flared end is formed by an orbital riveter.

4. A method as in claim 1 wherein the gas coupling is formed with automatic shutoff valves in each of a male and female coupling components, with each component including a valve holder assembly movably mounted in a valve chamber to open and close the valve, the process including forming the coupling with identical valve holders for the male and female coupling components, such that the valve holders for the male and female couplings are interchangeable.

5. A method as in claim 1 wherein the valve holder includes a stem that is slidably mounted for linear motion in an opening in a guide mounted in the valve chamber, the guide comprising an annular collar having legs around the outer periphery thereof that extend outwardly from the collar to an interior surface of the valve chamber, the guide being formed out of powdered metal.

6. A method of making a valve holder assembly for a shutoff valve incorporated in a pressurized gas coupling wherein male and female coupling components are joined together to connect a source of pressurized gas with a gas operated device, at least one coupling component having a shutoff valve therein, the shutoff valve including a body having an elongated valve chamber therein, with a valve seat at a valve port at one end thereof, a valve member being movably mounted in the valve chamber for movement between a closed position, wherein the valve member engages the valve seat and closes the valve port, and an open position, wherein the valve member is spaced away from the valve seat and the valve port is open, the valve member comprising an elongated metal valve holder having a compressible gasket mounted thereon in position to engage the valve seat, the method for forming the valve holder assembly comprising:
forming a valve holder in the form of an elongated member having a stem at one end and a nipple at the other end and having an outwardly extending radial flange positioned between the stem and the nipple, the valve holder having a cylindrical portion extending between the flange and nipple, the cylindrical portion and having a diameter greater than the diameter of the nipple but less than the diameter of the flange, the cylindrical portion having a shoulder at an outer end thereof;
providing an annular gasket of suitable compressible material for sealing engagement with the valve seat, the gasket being formed with an outer contour that mates with the contour of the valve seat, the gasket fitting sealingly over the cylindrical portion and having an outer end that abuts the flange, the gasket having an inner end that extends only a portion of the way to the shoulder at the end of the cylindrical portion;
providing a retaining washer that fits over the nipple and abuts the gasket on the cylindrical portion;
fitting the gasket on the cylindrical portion in abutting engagement with the flange;
fitting the retaining ring over the nipple into a position adjacent to the gasket; and
applying a rotary forming tool to the shoulder between the nipple and the cylindrical portion so as to cause the cylindrical portion to be flared radially outwardly so as to form a cap adjacent an outer side of the retaining washer, capturing the retaining washer between the cap and gasket, thereby holding the gasket on the valve holder.

7. A method as in claim 6 wherein the cylindrical portion on the valve holder includes a first portion of relatively enlarged diameter, on which the gasket fits, and a second portion of a lesser diameter on which the retaining washer fits, the first and second portions having a shoulder therebetween that abuts an outer side of the retaining washer when the retaining washer is captured on the valve holder by forming a flared cap on the inner end of the cylindrical portion.

8. A gas coupling having interfitting male and female components, with each component having an automatic shutoff valve biased to a closed position when the coupling is disconnected, each shutoff valve comprising a movable elongated valve holder assembly mounted in an elongated valve chamber having a valve port at an inner end surrounded by an annular valve seat, each valve holder assembly including an elongated valve holder formed of a formable, substantially non-compressible material, the gasket being formed of a compressible material that can form a gas-tight seal on a valve seat, the gasket being annular and being shaped to provide a sealing engagement with the valve seat, the gasket fitting over an inner end of the valve holder and being mounted on a cylindrical portion of the valve holder, with an outer side of the gasket abutting a radial flange on the valve holder, an inner side of the gasket being adjacent to a retaining washer fitted over an inner end of the valve holder, a portion of the valve holder adjacent an inner side of the retaining washer being mechanically deformed radially outwardly sufficiently to form a cap that locks the retaining washer and gasket on the valve holder.

9 A gas coupling as in claim 8 herein the male and female components are formed such that the valve holder assemblies therein are interchangeable.

10. A gas coupling as in claim 8 wherein each valve holder comprises a nipple extending inwardly from the gasket and a stem extending rearwardly from the gasket, the stem being slidably mounted for linear movement in the valve chamber by a guide that is mounted in the valve chamber, the guide having an opening therein that fits over the stem, the guide being formed from powdered metal.

11. A gas coupling as in claim 8 wherein a cylindrical portion having a first portion, on which the gasket is mounted, and a second portion of lesser diameter adjacent the gasket, with a shoulder being formed between the first and second portions, the retaining washer fitting on the second portion and abutting the shoulder between the first and second portions, the retaining washer being captured between said shoulder and the deformed cap.
